(19) United States
(12) Patent Application Publication
(10) Pub. No.: US 2006/0271577 A1
(43) Pub. Date: Nov. 30, 2006

(54) Automatic link generation for linking to relevant data records circumstantial to document processes

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 11/498,906

(22) Filed: Aug. 2, 2006

Related U.S. Application Data
(63) Continuation-in-part of application No. 10/368,999, filed on Feb. 19, 2003, now abandoned.
(60) Provisional application No. 60/359,526, filed on Feb. 22, 2002.

(51) Int. Cl. G06F 7/00

(52) U.S. Cl. 707/100

(57) ABSTRACT

A computerized document management system is disclosed in this invention. The computerized document processing system is installed in a data-handling device for processing a document. The computerized document management system includes a document process monitor for monitoring and recording in the document a set of circumstantial events taking place in the data-handling device during a period of time as the computerized document processing system is processing the document. In a preferred embodiment, the document process monitor further includes an event display for displaying the set of circumstantial events taking place in the data-handling device such as sending the document as an attachment to an e-mail message. In another preferred embodiment, the document process monitor further monitoring and recording a length of elapsed time of a processing session and a total number document-process actions performed. These activities may include the number of key stokes on the keyboard or words pronounced into the document through a voice input device during the length of elapsed time. In another preferred embodiment, the document process monitor further includes a link-pointer processor for establishing a pointer for linking to a linked data record related to one of the circumstantial events. In another preferred embodiment, the document process monitor further includes a relevant data record recorder for recording a relevant data-record information of a relevant data record relevant to a section of a document processed by the document process system.

This Application is benefited from a previously filed Provisional Patent Application 60/359,526 filed on Feb. 22, 2002 and patent application Ser. No. 09/483,317 filed on Jan. 14, 2000 and patent application Ser. No. 10/368,999 filed on Feb. 19, 2003.

### BACKGROUND OF THE INVENTION

1. Field of the Invention

This invention relates generally to document process management system to carry out document review, editing, content management, file or data-record links, and related processes. More particularly, this invention relates to a content-based and processing history-driven document management system for linking files, data-records and graphic images with automatic generated links made available and controllable by user to maximize productivity with enhanced document process and management features.

2. Description of the Prior Art

The processes of a common computer user in reviewing, editing and managing a document are faced with the difficulties that the document presented to the user as an “isolated file”. This isolated file is stored in an hierarchical levels of “directories” and “sub-directories” according to current techniques of document management system offers no traceable links or association as to the “flow of the thought processes” during various stages through which a document has been created, formulated and updated. Under current definition of file management system, a file is called an orphan if the file is not organized under a particular traceable directory. This orphan file can only be recognized by direct identification of the file name because there is no directory to trace this “isolated” file since it is not associated with any organizing frameworks. However, in the state of the art, the computer file management system is established according to an organizing framework for use by the computer. The organizing framework of the computer file system often provides no reference or association to data, records, images, messages or other files, that may be processed by a document processor in the processes of creating, maintaining and updating the document. Under current file management system, other than the user created organization principles of the directories and sub-directories, every document as now organized and categorized, is basically an “orphan” with respect to the “flow of thought processes”. Very limited data or traceable links are available according to the circumstances surrounding the creation, editing, changes and reconfigurations over the historical developments of a document. Because each document, as it is organized now, does not provide useful traces or associations, or sufficient historical data that the thought processes or information relevant to the user's thought processes and surrounding circumstances related to the creation and historical developments of the document.

For instance, a scientist writing a scientific paper may change a paragraph after receiving an electronic mail (e-mail) from a colleague to communicate information disclosed in a newly published article accessible through the Internet. The scientist reads the e-mail and reviews the article through an Internet link to that article accessible through a web-site then he made changes on the research paper he is writing. Under current method of document management system, after the changes are made to that paragraph of the paper, a traceable association retained in the document depends entirely on the human efforts by the scientist to include that newly published paper and the e-mail communication as a reference or footnote in the paper. The scientist may not include that article as a reference because the scientist may consider the newly published article is not truly directly relevant. Or, the scientist may forget to quote that reference, then the traceable association to that e-mail message and the newly published article is now retained only in the mind of the scientist and nowhere to be found in the records of the document. Furthermore, the circumstantial event that an e-mail is received by the scientist from a colleague is also not part of the record of the paper in the computerized document unless the scientist records such communication in the paper. Furthermore, after the first draft is completed, the research paper is sent through Internet to a friend at an email address of friend@review.org for review. The friend provides several suggestions about the research paper and sends these suggestions as an e-mail message. Based on those suggestions from the friend, the research paper is revised. Even though those events are very important in the processes of revising and completing the document, there are no records in the document that these events ever take place.

From above example, it is evident that the information and data that are important and relevant with regard to a segment of a document are generally related to the “flow of thoughts” processed in the mind of a document processor in processing the document. However, frequently the “flow of thoughts” is typically related to other documents, e.g., the e-mail received by the scientist and the newly published paper. The scientist opens and reviews the e-mail and read the article through Internet links to a web site. As a computer user the scientist reviews other documents while writing the paper but these other documents are treated as isolated and separate files stored according to a mechanical hierarchical computer filing system that is often untraceable from the paper stored in the computer as a document file. Within the subject document itself, the associations and links to those related and referenced documents are not recorded in any traceable form or provided with links for direct linking to these referenced and relevant data record or documents. When a computer user needs to process that document again at a later time, it becomes a challenge and, in most cases, relies on the document processor's memory, to recall the links and association in order to process the subject document again.

In addition to the limitation of lacking external links as described above, current art of document processor further lacks the links between relevant sections within the document. A very specific example is the arrangement of a document with graphic illustrations shown on different pages from relevant text descriptions often cause inconvenience in reading and understanding the contents of the document. Flipping back and forth between pages in attempt to correlate the textual descriptions to various graphic elements located on different pages often requires extra times and efforts. FIG. 1A illustrates a particular example from a patent document where the drawings shown as FIGS. 16A and 16B enclosed in a rectangular block 10 and all alpha-numeral designations therein described in FIG. 1B below are include in first part of the patent, typically starting from second page, as drawings of various preferred embodiments. While the description of these preferred embodiments are included in the last part of the patent document as that enclosed in another rectangular block 20 shown in FIG. 1B. The functional blocks 10 and 20 are added to indicate the graphic elements and the label and numeral assignments enclosed in these functional blocks are to be considered as one single graphic elements and these labels and numeral assignments are to be ignored as these labels and numeral assignments are shown for the purpose of illustrating ways of numeral assignments and not to use the numeral assignment for assigning any graphical element as that described in the present invention. Review of a patent document requires a document reviewer to simultaneously read the texts and view the drawings in parallel. Often, it is inconvenient not only because the document is required to flip back and forth between different parts of the document, but also relevant textual sections are also dispersed at different parts of the document. Especially, in a patent document, a claimed element may be described in the Detail Description of Preferred Embodiment, and then presented in several claims. The Examiner must review the drawings and the textual descriptions to determine if the claims have sufficient support. Such review must be carried out in greater details, particularly if the questions are related to how the elements are claimed. Even though the drawings are included in a patent document, it is often inconvenient and cumbersome to make best use of the drawings due to the arrangement of separating the drawings into particular section from the textual descriptions and the claims. Please refer also to FIGS. 1C and 1D for drawings enclosed in rectangular blocks 30 and 40 respectively as examples for drawings that were typically included in a technical paper and a technical manual. Again, a document reviewer has to search among many sections of document to find relevant descriptions of particular graphical elements to gain understanding of the descriptions.

Advancements in computer search and document management do not yet benefit or help the tasks that are carried out by a Patent Examiner of patent document reviewer. The “search engines” and “document linkers” or “desktop publishing” systems can link and associate textual or graphic terms between different documents, or can insert graphic drawings into different parts of the documents. However, none of these systems is provided to arrange and present the relevant information and data related to a particular graphical element for the convenience of review and understanding by relating or linking the textual descriptions or claimed terms to a corresponding graphic element.

Rivette et al. disclosed in U.S. Pat. Nos. 5,991,751 and 5,991,780 a system, method and computer program product for displaying a patent document and a patent image. The system and method are useful in reducing the stress in review a document by displaying the text in a side-by-side display page. However, a document reviewer is still required to look “left-and-right” to compare the textual descriptions with the displayed image for understanding the content of the documents. Simultaneous and side-by-side displays are not sufficient to completely resolve the difficulties faced by a document reviewer. Specifically, the spatial distance between the displayed graphic elements and the textual descriptions including the name of each displayed element prevents a direct and immediate association.

Therefore, there is still a need in the art of document management and information presentation to provide user options to overcome the above limitations. These user options should allow for adding traceable data or links related to and pointing to the information and file related to the thought processes and the surrounding circumstances in the creation, editing, changes, and reconfigurations of a document. Furthermore, it is also desirable that the document configuration is arranged such that the review and examination of the document is aided by the graphic elements included in the document. The automatic link generation systems and techniques, which are commonly available in the market, may be employed to link textual descriptions included in various sections of a document to a graphic element. Presentation of drawings together with the textual descriptions immediately near the graphic elements and also the claim languages may then be displayed when commanded by a document reviewer. The inconvenience and difficulties in reviewing and examining a document may then be resolved.

### SUMMARY OF THE PRESENT INVENTION

It is therefore an object of the present invention to provide a document management system for storing and/or enabling the linking to and display of processing-history-relevant data-records as reference data-records such that the aforementioned difficulties and inconveniences can be resolved. Such data records may include data records particularly useful for a document creator to recalls the circumstances in generating the document. Such data records may include data records related to information or particular circumstances relevant to the contents of the documents such that the documents or a file with the added historical or circumstantial data records is placed appropriately in a historical or time-sequence context.

Specifically, it is an object of the present invention to provide a computerized document processing and management system with a processing event monitor for monitor the processing events take place during a processing section. The process event monitor further includes a processing event relevant database for storing data records and/or data record links for storing or linking to data records relevant to the processing events. The processing event monitor further includes a circumstantial event monitor for monitoring and recording contemporaneous circumstantial events occurs on a computer during a time period of a document processing sections and/or a predefined time period prior to the document processing session. These circumstantial events may include time and date and length of the document processing session, document processing actions taken and various kinds of events such as linking to an Internet website or sending the document in a sub-folder as a network mail item to particular recipients. Records of the circumstantial events would often serve to remind a user of the document processing and management system the history and circumstances during the formation and updating processes of a document. The generation and memory storage of such data records may be automatic, or may be user's option or an option after presenting to a user for user's after-review selection as to what and how the records are stored as part of the document processing history file.

It is further an object of this invention to provide a computerized document processing and management system for generating a document that includes a database for storing processing event relevant data record and/or links to relevant data records. The database is available for a user of the document processing and management system to review and use the document processing event relevant data records to enhance the productivity of document processing activities by significant reducing the efforts necessary to search such relevant data records.

Briefly, in a preferred embodiment, the present invention includes a computerized document processing system installed in a data handling system for processing a document. The computerized document processing system includes a document process monitor for monitoring and recording in the document a set of circumstantial events taking place in the data handling system during a period of time including a point of time when the computerized document processing system processing the document. In a preferred embodiment, the document process monitor further includes an event display for displaying the set of circumstantial events taking place in the data handling system. In a preferred embodiment, the document process monitor further monitoring and recording a length of elapsed time of a processing session and a total number document-process actions performed during the length of elapsed time. In a preferred embodiment, the document process monitor further includes a pointer-linking means for establishing a link to a linked data record. The linked data-record is related to one of the circumstantial events as a linked event displayed in the set of circumstantial events by the event display using the linked event as a linking pointer. In a preferred embodiment, the document process monitor further includes a relevant data record means for recording a data-record information of a relevant data record for an object-of-process data record in the document. The document process monitor monitors a relevant processing action to determine that there is a likelihood of relevancy between the object-of-process data record and the relevant data record. In a preferred embodiment, the data record linking means further comprising a link-indication means for providing an indication of a link existed for linking a user designated data record in the document to a linked data record. In a preferred embodiment, the data record-linking means further includes a display means for displaying the link for linking the user designated data record in the document to a linked data record. In a preferred embodiment, the data record-linking means further includes a linked-data-record display means for displaying the user designated data record in the document together with the linked data record. In a preferred embodiment, the data record-linking means further includes a network linking means for linking the user designated data record in the document to the linked data record via a computer network. In a preferred embodiment, the data record-linking means further includes a graphic element linking means for linking the user designated data record in the document to a linked graphic data record. In a preferred embodiment, the data record-linking means further comprises a linked-graphic-data-record display means for displaying the user designated data record in the document together with the linked graphic-data record.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIGS. 1A is a typical patent drawing included in the first part of the patent document;

FIG. 1B shows a relevant descriptions for the drawing of FIG. 1A printed on a last part of the patent document;

FIGS. 1C to 1D are drawings included in a technical paper and a technical manual generally separated from the sections of descriptions related to the graphical elements;

FIG. 2 is a functional block diagram of a document management system according to the present invention;

FIG. 3 is a flowchart for illustrating the processing steps for carrying out a document management process of this invention;

FIGS. 4A to 4C show a graphic presentation with better correlation between the textual descriptions and the relevant graphic element as processed by the document management system of this invention;

FIG. 5 is a functional block diagram of a document processing and management system of this invention; and

### DETAILED DESCRIPTION OF THE PREFERRED EMBODIMENT

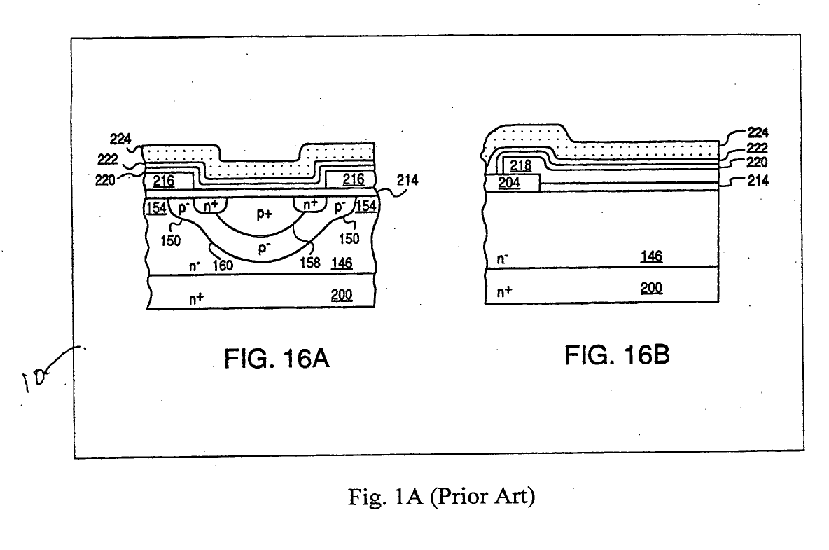

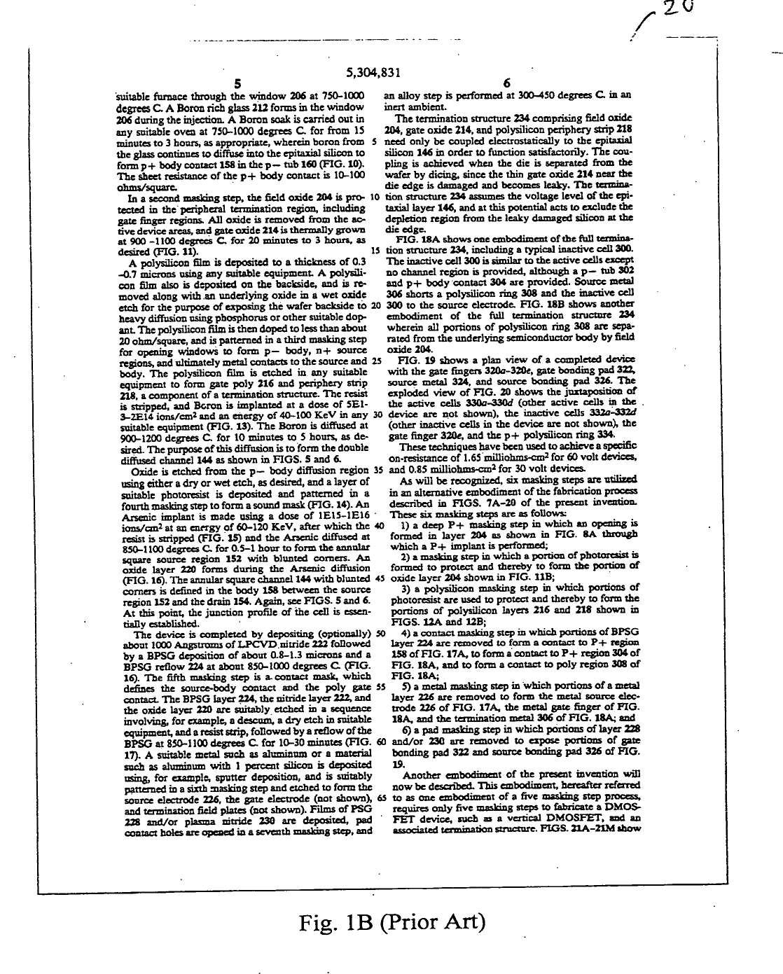

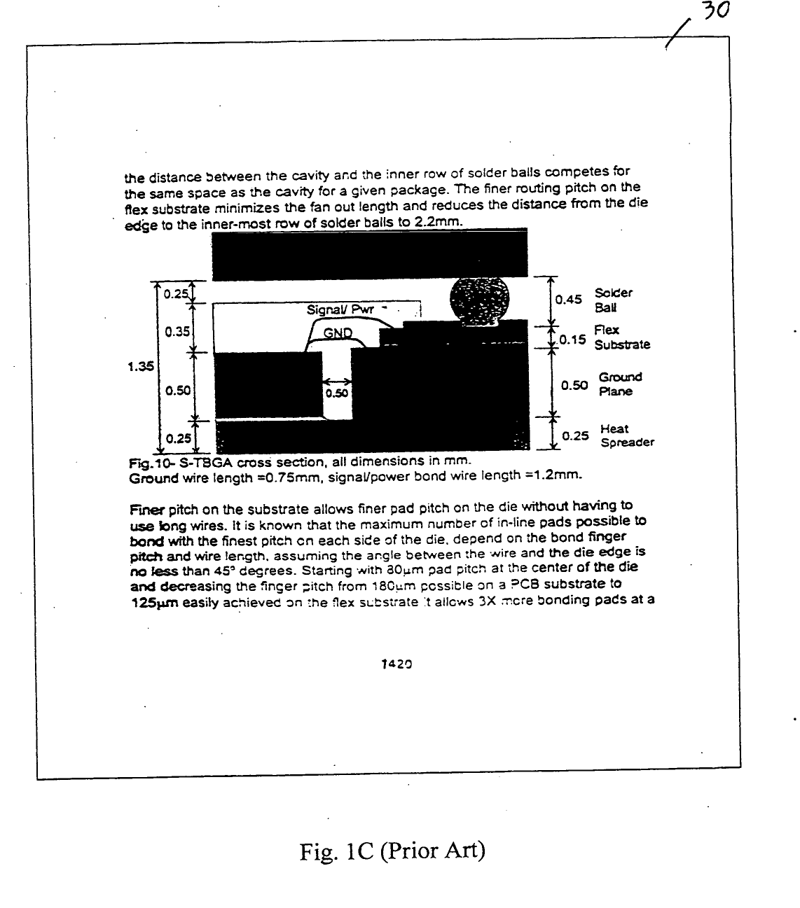

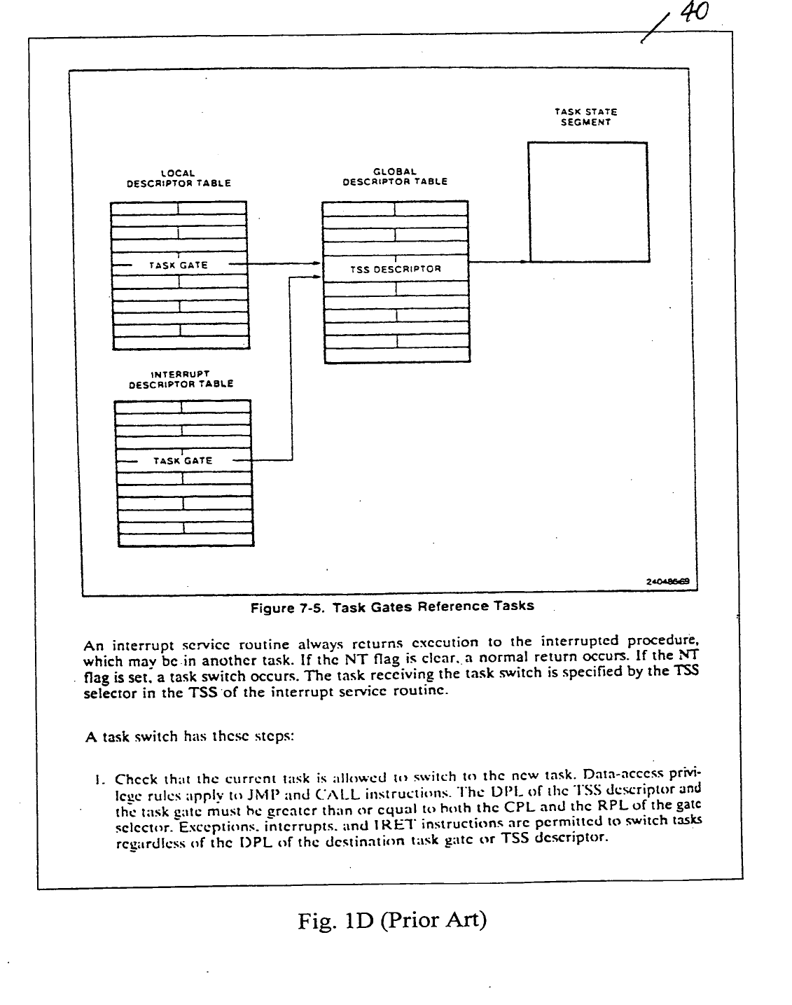

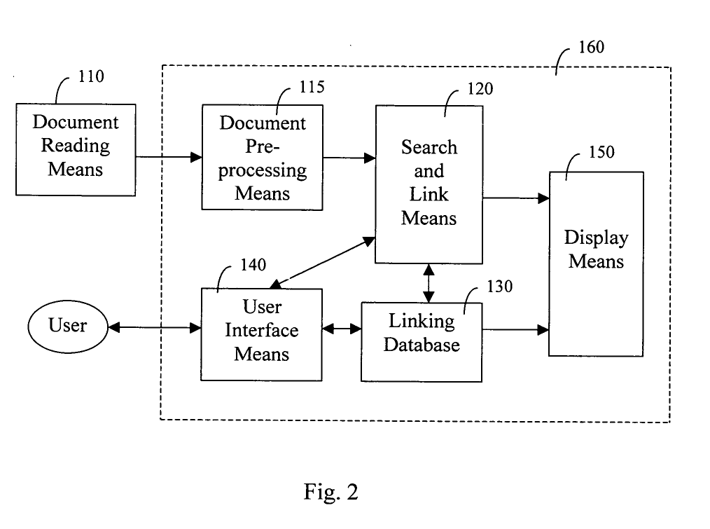

FIG. 2 is a functional block diagram for illustrating a document management system 100 of this invention. The document review management system includes a document reading means 110 for receiving a document either in processor-recognizable form, i.e., commonly called soft-copy or electronic-copy, or a hard-copy, e.g., a paper copy. The document management system 100 further includes a document preprocessing means 115 for converting the input document on a hard copy to a processor recognizable form. The input document after it is converted to its processor-recognizable form also includes the graphic element each associated with a processor-recognizable alpha-numeral designation. The alpha numeral designation for each graphic element is either a numeral designation most commonly used in the drawings of a patent document (FIG. 1A) or a textual name often used in a technical paper (FIG. 1C), or user manuals (FIG. 1D).

The document management system 100 further includes a search and link means 120. The search and link means 120 applies each of the alpha-numeral designations for each of the graphic elements to perform a search and link operation. A search is first performed to search for a naming-term for an alpha numeral designation. For a patent document, the designation of a graphic element is usually a numeral designation. A naming-term associated with that numeral designation is first searched and identified. The document management system further includes a linking database 130. For each identified naming-terms or an alpha-numeral designation, the entire document is searched to establish an associated text-file and all of these text files are stored in the linking database. The document system further includes a user interface means 140, which could be graphic user interface (GUI) to receive user command to perform different document management functions. The document management system 100 further includes a display means 150 that could be a monitor of a personal computer for showing the graphic display of the document and the associate text descriptions. In a typical preferred embodiment, the document pre-processing means 115, the search and link means 120, the lining database 130, the user interface means 140 and the display means 150 are incorporated in a personal computer (PC). And, the document reading means 110 is a document scanner 110 for scanning a document and generates an output to the PC for further textual and graphic processing.

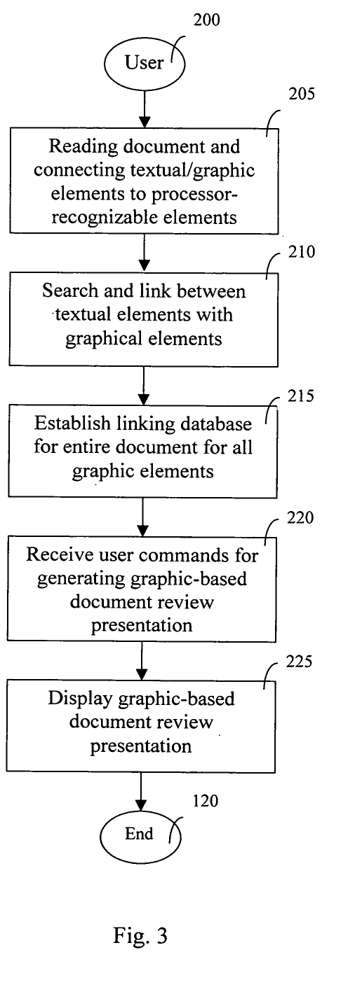

FIG. 3 is a flow chart for illustrating the processing steps carried out by the document management system 100 for providing a graphic-based review version of an input document that includes several sections having textual descriptions and drawings. The document management process begins (step 200) by reading the document and converting the textual and graphic elements of the documents into processor recognizable textual and graphic elements (step 205). The processor-recognizable textual and graphic elements are then processed by the search and link means 120 to search the document by using the alpha-number designations of each of the graphical elements to identify a naming-term in the section of the textual descriptions for each graphic element (steps 210). With a specific naming-term identified for each graphic element, further searches are conducted over the entire document to establish a link database 130 to provide a list. The list links every sentence in the document containing a reference of either the naming-term or the alphanumeric designation of each graphic element (step 215). For each sentence in the document for a graphic element, the link database further lists the column, e.g., column 4, or page number, e.g., page 135, and also the line number, e.g., lines 20 to 25, to identify the location of that description related to the graphic element. The document management system 100 further provides to a user a graphic user interface (GUI) for a document reviewer to input commands for providing various kinds of graphic-based document review presentations (step 220). In responding to the user commands, a graphic-based document review presentation is displayed on the display means of the document management system 100 (step 225).

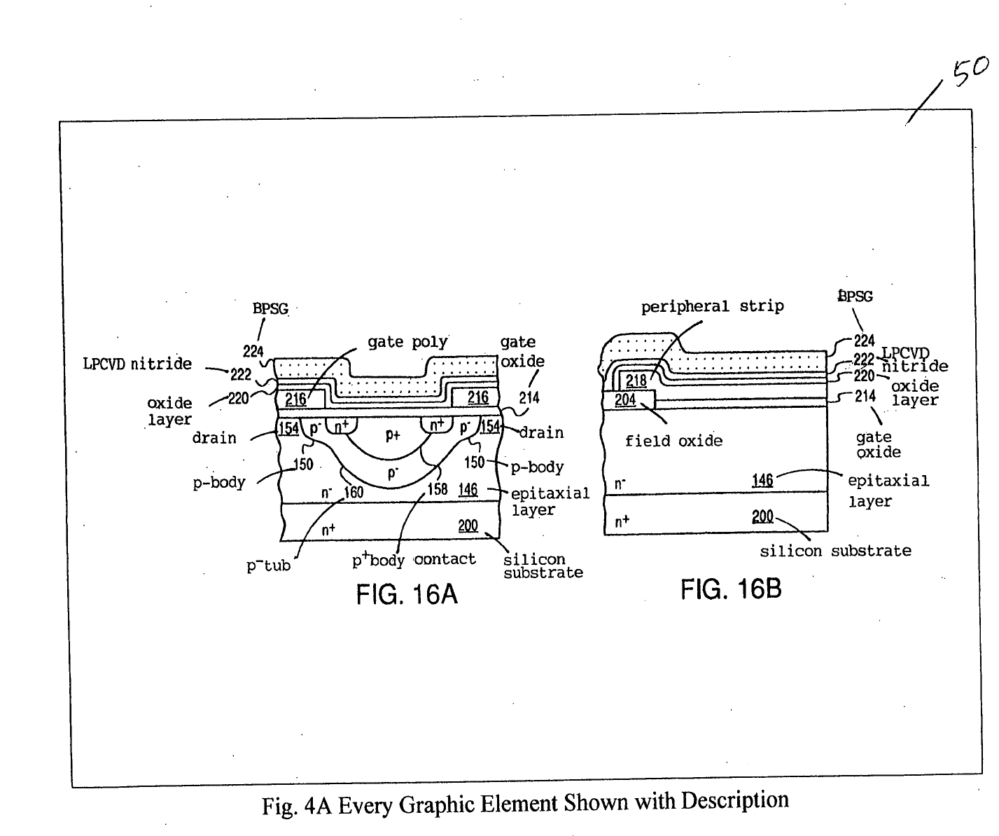

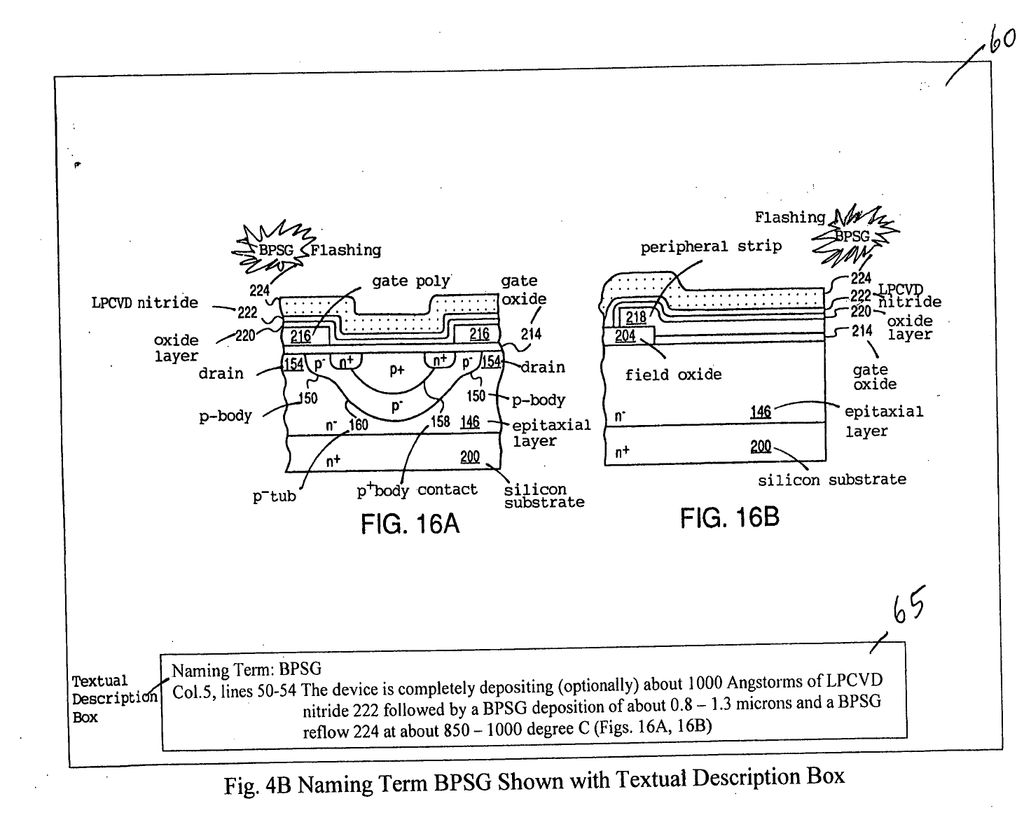

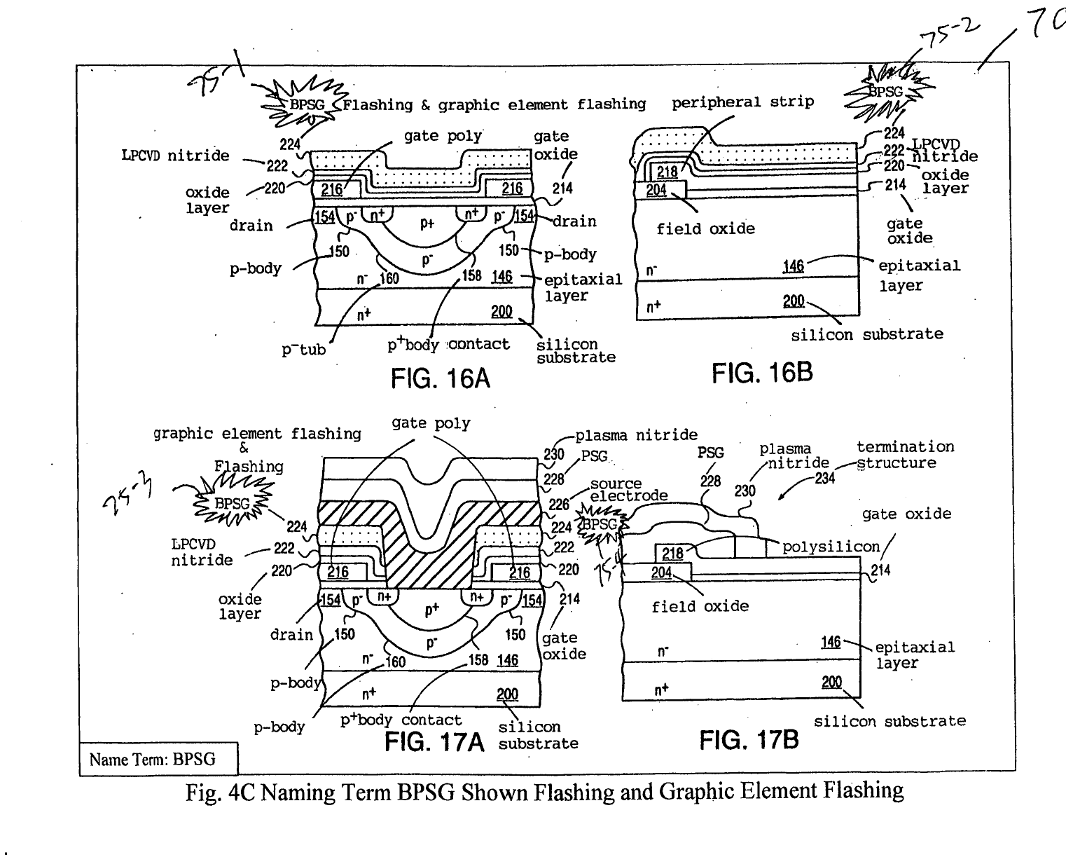

FIG. 4A is an exemplary display of a graphic-based review-document as processed by the document management system of this invention. For each graphic element, a user has several options for selecting a graphic representation of each drawing included in the document. These options are describe below:
1) A user can select to display a drawing with each of the alpha-numeral designations displayed side-by-side with a naming-term as that shown in FIG. 4A where FIG. 16A and FIG. 16B as enclosed in rectangular block 50 similar to that shown in FIG. 1A but with naming terms displayed next to the alpha-numeral designations and all alpha-numeral designations described in FIG. 1B.
2) A user can then select one or several graphic elements by double clicking on the alpha-numeral designation or the naming-term to display a textual-description box next to the graphic element. The textual description box will also display the column number, page number and line number for each textual description to provide location of these relevant textural descriptions in the document. An alpha-number designation may include a drawing designation such as “FIG. 4A”. Upon a user's double click on “FIG. 4A” the textual description box will display relevant textual description for “FIG. 4A”. For a patent document, the claim number and line number will also be shown associated with the naming term associated with the alpha-numeral designation (See FIG. 4B for FIGS. 16A and 16B enclosed in rectangular block 60 and also the textual description box 65 and other alpha-numeral designations described in FIG. 1B).
3) A user is also provided with an option to input a user-selected naming-term as input. In response to the user-selected input naming-term, the document management system will link to one or several drawings of the document associated with the user-selected naming-term. (See FIG. 4C for FIG. 16A FIG. 16B, FIGS. 17A and 17B enclosed in rectangular block 70 and also the flashing naming terms 75-1, 75-2, 75-3, and 75-4 and other alpha-numeral designations described in FIG. 1B) The document management system will show the first drawing associated with the user-selected naming-term. The document management system will also show all the naming-terms associated with all the alpha-numeral designations of that drawing. The user then has the options to examine more drawings and the detail descriptions for each of the graphic element based on options 1) or 2) above. The display means 150 of the document management system 160 further provides a highlight display for the graphic elements for each of the naming terms. The highlight display may be in special color, special bold profile of the graphic elements or a flashing display for each of the graphic elements when user point a cursor to a particular naming-term in the textual description box shown side by side with the drawing or drawings.

A Patent Examiner is often encountered with the requirements of linking all the claimed elements to supporting descriptions, either textual or graphical, provided in the entire document. The document management system 100 as disclosed here can conveniently aid and enhance the examination of a patent document. In addition to the benefits of more conveniently linking the textual descriptions to the graphical elements in the documents, the document management will aid to the quality of document examination. This is because better understanding of the document will be enhanced with presentations between the textual descriptions correlated to the graphic elements showing as graphical presentations. For patent examination, a Patent Examiner can easily find out if any term included in a claim is supported in the Specification or Drawings by entering that term to invoke a graphic display and the column and line numbers for description of that term.

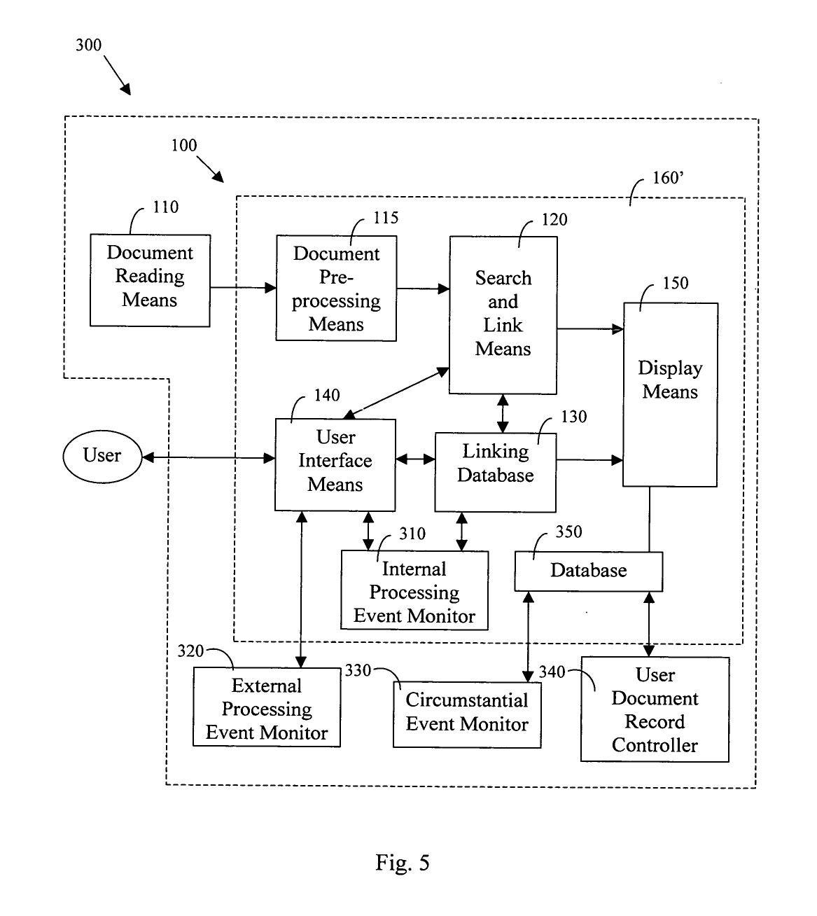

Referring to FIG. 5 for a functional block diagram of a document process system 300 of this invention. In a preferred embodiment, the document processing system 300 includes the document management system 160′ similar to that shown in FIG. 2 as part of the total system. The document management system 160′ also includes an internal processing event monitor 310 to monitor the document processing events taking place internal to the document such as cutting a section of the document and pasting the cut section to a different section. An internal link is established to link these two sections as related sections internal to the document. A link is then stored in the linking database 130 to link two internal sections of the document. A user is also provided with an option to store or remove the internal link between two sections of the document under process. A link for each section of document may appear as a footnote for showing a link to a section of the document indicated with the page and paragraph numbers of the linked section. As a user click on the link shown on the bottom of a page display, the linked internal section of the processed document may be displayed in different fashions. One of the display options is to display the linked section side-by-side with the linking document section or shown as a “bubbled display” that can be turned on and off at user's command.

The document process system 300 further includes an external processing event monitor 320 to monitor and record an “external” document process event. The “external document process events” may include a processing step such as copy and paste a section from an external document, open anther document to review a section of that opened document for reference. The reference documents may be linked through the Internet websites, or an electronic mail received through a mail server. Again, a user option is provided for the user to select either to store or remove a link for linking a section of document to the external document, Internet Websites or mail messages using as reference documents during a document processing session. The user is further provided with an option to store one or several relevant sections of the linked document in an indexed “reference database” with a linking reference title stored in the database. The linking reference titles are then displayed as a footnote along with the linking section of the document. A user is provided with an option to retrieve and display the stored reference information from the reference database either side-by-side or as a “bubbled display” along with each linking section of the document for ready reference to enhance the efficiency and convenience for the process of the document.

The document process system 300 further includes a circumstantial event monitor 330 for monitoring the circumstantial events taking place in the computer contemporaneously with the document processing activities. The circumstantial events may include the monitoring and recording of elapsed length of time for processing the document and total number and types of processing actions or activities. The document processing actions or activities may include the number of keyboard stokes, cut and paste activities, number of syllables of voice commands or all other types of activities related to document processing. The circumstantial event monitoring may also includes “recent document list” listing all the documents processed on the computer within last twenty four or forty eight hours and application program invoked and filed created or updated during that time period. The circumstantial event monitor 330 may also record the e-mail addresses or network ID of the recipients to whom the document is sent, or a graphic file that contains drawings that were printed within a certain time period before or after the document processing activities take place. As part of the record, the productivity of document process may be greatly improved. Because all these circumstantial events often provide useful information related to the “thought processes” that may be relevant to provide references for linking to ideas, concepts, images, or any circumstantial events during the production or process of a document. Again, the circumstantial events are recorded and stored in a database 350 under the control of a user document record controller 340 to store or remove such record for future references.

According to FIG. 5 and above descriptions, a computerized document management system is disclosed in this invention. The computerized document processing system installed in a data-handling device for processing a document. The computerized document management system includes a document process monitor for monitoring and recording in the document a set of circumstantial events taking place in the data-handling device during a period of time as the computerized document processing system is processing the document. In a preferred embodiment, the document process monitor further includes an event display for displaying the set of circumstantial events taking place in the data-handling device such as sending the document as an attachment to an e-mail message. In another preferred embodiment, the document process monitor further monitoring and recording a length of elapsed time of a processing session and a total number document-process actions performed. These activities may include the number of key stokes on the keyboard or words pronounced into the document through a voice input device during the length of elapsed time. In another preferred embodiment, the document process monitor further includes a link-pointer processor for establishing a pointer for linking to a linked data record related to one of the circumstantial events.

Therefore, the present invention provides a document management system for storing and enabling the linking to and display of t relevant data records as reference data records. Specifically, a computerized document processing and management system with a processing event monitor to monitor the processing events take place during a processing section is disclosed. The process event monitor further includes a processing event relevant database for storing data records and/or data record links for linking to data records relevant to the processing events. The processing event monitor further includes a circumstantial event monitor for monitoring and recording contemporaneous circumstantial events occurs on a computer during a period of a document processing sections or a predefined time period prior to the document processing session. These circumstantial events may include time and date and length of the document processing session, document processing actions taken and various kinds of events such as linking to an Internet website. Records of the circumstantial events as part of the document would often serve to remind a user of the document processing and management system the history and circumstances during the formation and updating processes of a document. The stored data is available for review and use the document processing event relevant data records to enhance the productivity of document processing activities when efforts necessary to search such relevant data records can be significantly reduced.

The database 350 is therefore becomes a part of a document file to serve the function of a “historical record” that is available for review by a document file processor, e.g., a user of the document file editing and processing system as shown in FIG. 5. The user may further enter and record a historical or thought process related entry into the database function as a historical record as part of the document file. The entry may be a picture, an e-mail, a piece of music, a video clip, or anything that may enhance the user to recall the circumstances when generating or editing the document file or to provide a time-sequence records of how and why the document is formulated, processed and revised. For instance, a customer service document file may include at a textual document file including at least one historical record that records all the telephone conversations with one particular account manager. The textual document file may list all relevant information for that account manager. Particular sections of the textual document file are linkable to the telephone conversation records relevant to the sections of the textual document file. Therefore, each document file is now placed into a historical and time-sequential context relevant to the generation, editing, revising, processing and continuously changing events available for a user to review, use and process.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A data handling processor for generating data records relating to histories of content changes of a computerized file comprising:
a content editing process monitor for recording a length of elapsed time of a processing session of said computerized file and keeping a separate data record as part of the computerized file for recording histories of content-change processing actions performed during said length of elapsed time.

2. A computerized file editing processor installed in a data handling system for processing a computerized file comprising:
a content editing process monitor for monitoring a set of circumstantial events taking place in said data handling system and recording said set of circumstantial events in a historical data record as a part of said computerized file for keeping a record of content-change processing actions as said computerized file editing processor processing said computerized file.

3. The computerized file editing processor of claim 2 wherein:
said content editing process monitor further comprising an event display for displaying said set of circumstantial events taking place in said data handling system.

4. The computerized file editing processor of claim 2 wherein:
said content editing process monitor further monitoring and recording a length of elapsed time of a processing session and keeping said length of elapsed time in said historical data record as histories of content-change processing actions.

5. The computerized file editing processor of claim 2 wherein:
said historical data record for keeping said record of said content-change processing actions further storing a link record for linking a section of said computerized file to a data record processed in one of said content change processing actions.

6. The computerized file editing processor of claim 2 wherein:
said historical data record for keeping said record of said content-change processing actions further storing a pointer for pointing to a data record processed in one of said circumstantial events taking place in said data handling system during said period of time.

7. The computerized file editing processor of claim 2 wherein:
said historical data record for keeping said record of said content-change processing actions further storing a pointer to an Internet website when said Internet website is accessed in one of said circumstantial events taking place in said data handling system during said period of time.

8. The computerized file editing processor of claim 2 wherein:
said historical data record for keeping said record of said content-change processing actions further storing a link record for linking a section of said computerized file to an electronic mail (e-mail) processed in one of said content change processing actions.

9. The computerized file editing processor of claim 2 wherein:
said historical data record for keeping said record of said content-change processing actions further storing a link record for linking a section of said computerized file to a data record in another section of said computerized file processed in one of said content change processing actions.

10. The computerized file editing processor of claim 2 wherein:
said historical data record for keeping said record of said content-change processing actions further storing a link record for linking a section of said computerized file to a data record in another computerized file processed in one of said content change processing actions.

11. The computerized file editing processor of claim 2 wherein:
said historical data record for keeping said record of said content-change processing actions further storing a link record for linking a section of said computerized file to a data record in another computerized file stored in a networked data handling system processed in one of said content change processing actions.

12. The computerized file editing processor of claim 2 wherein:
said historical data record for keeping said record of said content-change processing actions further storing a link record for linking a section of said computerized file to a graphic data record in another computerized file processed in one of said content change processing actions.

13. The computerized file editing processor of claim 2 wherein:
said content editing process monitor further recording a transmission of said computerized file via an Internet as one of said circumstantial events taking place in said data handling system.

14. A computerized file editing processor installed in a data handling system for processing a computerized file comprising:
a content editing process monitor for monitoring content editing activities of said computerized file and for automatically establishing a data record for providing links between an edited data record in said computerized file to a linked data record accessed during a file content editing process.

15. The computerized content editing processor of claim 14 wherein:
said content editing process monitor further comprising a link-indicator for indicating a linked data record linking to said edited data record of said computerized file is stored in said data record.

16. The computerized content editing processor of claim 14 wherein:
said data record further storing a pointer pointing to an Internet website for linking said edit data record in said computerized file when said Internet website is accessed during a file content editing process.

17. The computerized content editing processor of claim 14 wherein:
said data record further storing a link record for linking said edited data record in said computerized file to an electronic mail (e-mail) when said electronic mail is accessed during a file content editing process.

18. The computerized content editing processor of claim 14 wherein:
said data record further storing a link record for linking said edited data record in said computerized file to another section of said computerized file when said another section is accessed during a file content editing process.

19. The computerized content editing processor of claim 14 wherein:
said data record further storing a link record for linking said edited data record in said computerized file to a data record in anther computerized file when said data record in another computerized file is accessed during a file content editing process.

20. The computerized content editing processor of claim 19 wherein:
said data record further storing a link record for linking said edited data record in said computerized file to a data record in anther computerized file stored in a networked data handling system when said data record in another computerized file stored in said networked data handling system is accessed during a file content editing process.

21. A computerized content editing processor for processing a computerized file comprising:
a content editing process monitor for monitoring and automatically generating a data record for recording a set of computerized files accessed during an editing process of said computerized file.

22. A computerized file comprising:
a data record for storing editorial histories of said computerized file including a sequence of editing processing events and a set of circumstantial events taking place in a data handling system employed for editing said computerized file.

23. The computerized file of claim 22 wherein:
said data record further storing a link record for linking an edited data record in said computerized file to another data record accessed during a file content editing process.
